(19) United States
(12) Patent Application Publication
(10) Pub. No.: US 2009/0241778 A1
(43) Pub. Date: Oct. 1, 2009

(54) Use of Solvent Stream as Motive Fluid in Ejector Unit for Regenerating Solvent for Absorption Unit

(76) Inventors: William J. Lechnick, Glen Ellyn, IL (US); Lamar A. Davis, West Dundee, IL (US); Michael R. Van de Cotte, Palatine, IL (US); John P. Brady, Algonquin, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/055,909

(22) Filed: Mar. 26, 2008

(51) Int. Cl. B01D 53/14; B01D 19/00; B01D 53/18

(52) U.S. Cl. 95/177; 96/181

(57) ABSTRACT

The invention provides a process and system for regenerating a solvent used to remove carbon dioxide from feed gases, such as natural gas and synthesis gas. The process and system employs an eductor or ejector as an alternative to the prior art's vacuum compressor that is placed on the vapor stream from a vapor flash. This process and system saves substantial capital and operating costs over the prior art.

### BACKGROUND OF THE INVENTION

This invention is related to the removal of acid gases from a feed gas. More particularly the invention relates to acid gas removal from high carbon dioxide and hydrogen sulfide containing feed gases. A process is provided for reduced energy requirements in the regeneration of the solvent used to remove the acid gases.

Absorption systems are commonly used for the removal of CO₂ from natural gas or synthesis gas. A physical solvent such as a dimethylether of polyethylene glycol (DMPEG) can be used to wash out carbon dioxide. DMPEG solvents are used in systems licensed by UOP LLC under the trademark Selexol™. Cryogenic methanol systems are also known to those skilled in the art for this use including the Rectisol™ process currently licensed by Lurgi AG. Other physical solvents that may be used include a mixture of N-formyl and N-acetyl morpholine, N-methyl-2-pyrrolidone and sulfolane.

After absorption of carbon dioxide and/or hydrogen sulfide and/or carbonyl sulfide by a physical solvent, the solution is regenerated to remove absorbed gases. The regenerated physical solvent can then be recycled for further absorption. Absorption and regeneration are usually carried out in different separator columns containing packing or bubble plates for efficient operation. Regeneration is generally achieved in two stages. First, the absorbent solution's pressure is reduced so that absorbed carbon dioxide is vaporized from the solution in one or more flash vessels, sometimes terminating with a vacuum flash drum. Next, if thermal regeneration is required, the flashed absorbent is stripped with steam in a stripping regenerating column to remove residual absorbed carbon dioxide. Low carbon dioxide levels are needed in order to achieve the required carbon dioxide specifications for treated gas.

In the prior art processes, a vacuum compressor, which is very expensive in terms of both capital and operating costs, is placed on the vapor stream from the vacuum flash drum so that the carbon dioxide can be vented to the atmosphere or recompressed for further use. In the past, other configurations that used eductors or steam ejectors were considered to reduce these costs, but the motive fluid or steam requirements needed were too large to make these options acceptable alternatives.

For the first time, an invention has been developed that would reduce the high cost requirements of this process.

### SUMMARY OF THE INVENTION

The present invention involves the use of a solvent stream as the motive fluid at the elevated pressures typical of the process eliminating the high costs previously encountered in regenerating the solvent stream. The motive fluid that is used can be the bottom stream from a carbon dioxide absorber unit or the liquid from the carbon dioxide recycle flash drum depending upon the configuration of the system. The pressure of the recycle flash drum can be varied as needed and in certain circumstances the drum can be removed if there is a need for additional energy. The operating pressure of the carbon dioxide absorber ranges from about 400 to 950 psia so that sufficient energy would be available to be transferred from the fluid exiting the adsorber to compress the gas flow typical of the vacuum flash. This invention is applicable to any process in which vacuum regeneration of a solvent used in a high pressure process is sought.

The present invention involves a process for treating a carbon dioxide containing gas comprising sending a feed gas containing carbon dioxide through an absorber unit containing a lean solvent to produce a loaded solvent containing a majority of said carbon dioxide from said feed gas and a treated gas, sending at least a portion of said loaded solvent through an eductor together with a carbon dioxide containing gas from a downstream vacuum flash drum to produce a gas-liquid mixture under increased pressure wherein said gas-liquid mixture comprises a solvent composition and said carbon dioxide, sending said gas-liquid mixture to a carbon dioxide vent drum to vent a majority of said carbon dioxide from said gas-liquid mixture, sending the liquid from said vent drum to a vacuum flash drum with vacuum induced via the eductor mentioned above to produce a semi-lean solvent stream, and recirculating said semi-lean solvent stream to said absorber unit.

The invention also involves a system for removal of carbon dioxide from a carbon dioxide containing solvent comprising a carbon dioxide absorber, a carbon dioxide recycle flash drum, a vacuum flash drum, an eductor and a carbon dioxide venting apparatus.

The invention is generally applicable to physical solvents for which a vacuum flash is used in the thermal regeneration of the solvent stream to produce a solvent stream that contains almost no acid gas. Among the physical solvents that can be used are a dimethylether of polyethylene glycol (DMPEG), methanol, a mixture of N-formyl and N-acetyl morpholine, N-methyl-2-pyrrolidone and sulfolane. Dimethylether of polyethylene glycol is a preferred solvent for use in the present invention.

### BRIEF DESCRIPTION OF THE DRAWINGS

FIG. 1 shows the prior art process in which vacuum flash is used to regenerate the solvent in the carbon dioxide capture section with removal of carbon dioxide using a vacuum compressor.

FIG. 2 shows one flow scheme in which an eductor or ejector is used to regenerate solvent in the carbon dioxide capture section.

FIG. 3 shows an alternative flow scheme in which an eductor or ejector is used to regenerate solvent in the carbon dioxide capture section.

### DETAILED DESCRIPTION OF THE INVENTION

The present invention employs an eductor, also referred to as an ejector to eliminate the use of a vacuum compressor in the regeneration section of a solvent based absorption system. In the prior art systems, a vacuum compressor was required to eliminate the carbon dioxide from the vacuum flash. The vacuum compressor has very significant electricity requirements as well as equipment costs that can be as high as 5 million dollars per system. Significant savings can be provided by use of an eductor or ejector.

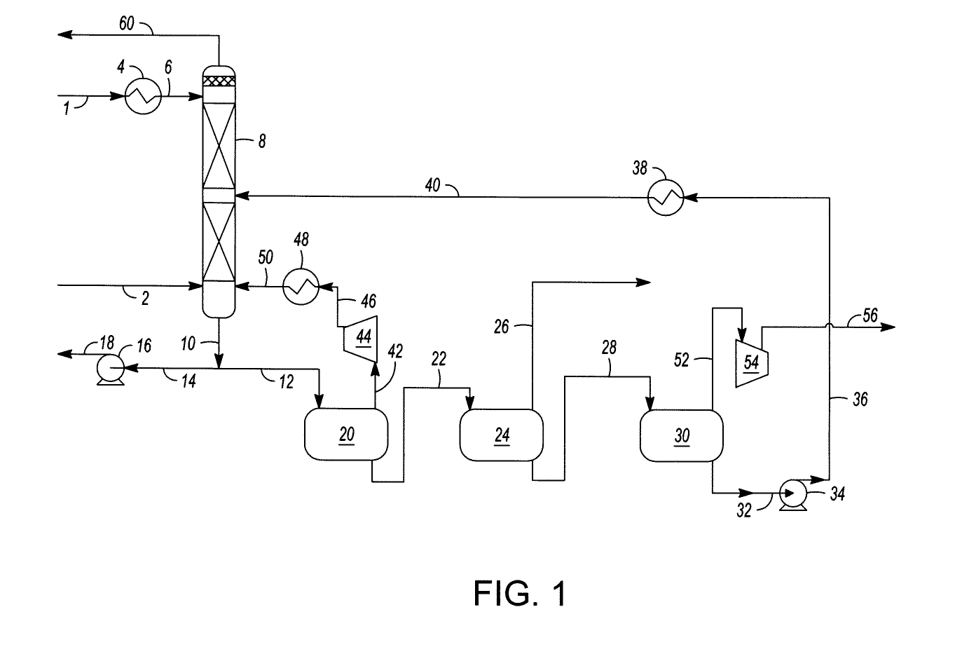

A prior art system is shown in FIG. 1 in which a lean solvent 1 that has a low level of acid gases is chilled by lean solvent chiller 4. The chilled lean solvent 6 enters carbon dioxide absorber unit 8 to contact a feed gas shown as entering carbon dioxide absorber unit through line 2. The contact of the chilled lean solvent with the feed gas results in a loaded solvent exiting the bottom of the carbon dioxide absorber unit 8 through line 10. A portion of the loaded solvent passes through line 14 to loaded solvent pump 16 and then exits this portion of the process through line 18 where the loaded solvent is sent either to another absorber unit to remove other impurities such as hydrogen sulfide or to be regenerated. The remaining portion of the loaded solvent is sent through line 12 to be flashed in recycle flash drum 20 so that a portion of the carbon dioxide exits the top of the recycle flash drum 20 through line 42 to be compressed in recycle compressor 44, go through line 46, cooled in cooler 48 and then reenter carbon dioxide absorber unit 8 through line 50. The partially regenerated solvent leaves recycle flash drum 20 through line 22 and then goes to vent drum 24. Most of the carbon dioxide is vented from vent drum 24 through line 26. The partially regenerated solvent from vent drum 24 passes through line 28 to vacuum drum 30 to produce a semi-lean solvent that flows through line 32 to solvent pump 34. A gaseous carbon dioxide portion passes through line 52 to vacuum compressor 54 and then exits the system through line 56. The semi-lean solvent then continues through line 36 to semi-lean solvent chiller 38 and then through line 40 to carbon dioxide absorber unit 8. Also shown in the drawing is treated gas leaving the top of carbon dioxide absorber unit 8 through line 60.

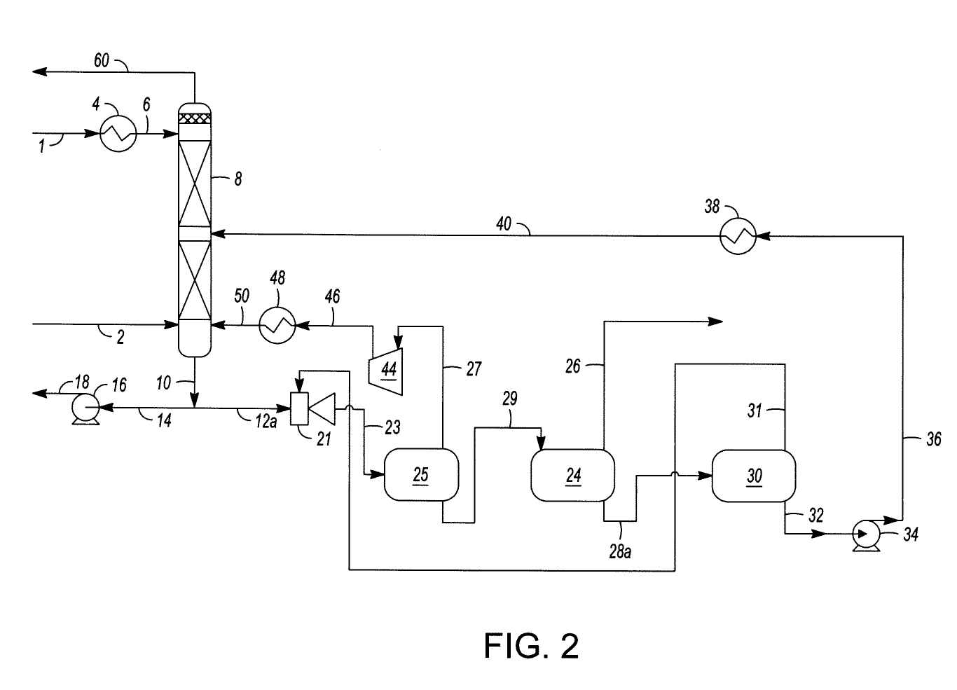

FIG. 2 shows an embodiment of the invention in which an eductor is used in the regeneration of the solvent in the carbon dioxide capture section of a gas treatment plant. A lean solvent 1 that has a low level of acid gases is chilled by lean solvent chiller 4. The chilled lean solvent passes through line 6 and enters carbon dioxide absorber unit 8 to contact a feed gas or a gas from another absorber unit shown as entering the carbon dioxide absorber unit through line 2. The contact of the chilled lean solvent with the feed gas results in a loaded solvent exiting the bottom of the carbon dioxide absorber unit 8 through line 10. A portion of the loaded solvent passes through line 14 to loaded solvent pump 16 and then exits this portion of the process through line 18 where the loaded solvent is sent either to another absorber unit to remove other impurities such as hydrogen sulfide or to be regenerated. The remaining portion of the loaded solvent is sent through line 12a to eductor 21 and then through line 23 to recycle flash drum 25 with a portion of the carbon dioxide exiting through line 27 to be compressed in recycle compressor 44, go through line 46, cooled in carbon dioxide recycle cooler 48 and then reenters carbon dioxide absorber unit 8 through line 50. The partially regenerated solvent leaves recycle flash drum 25 through line 29 and then goes to vent drum 24. Most of the carbon dioxide is vented from vent drum 24 through line 26. The partially regenerated solvent from vent drum 24 passes through line 28a to vacuum drum 30 to produce a semi-lean solvent that flows through line 32 to solvent pump 34 and a gaseous carbon dioxide portion that passes through line 31 to the eductor 21 to be recompressed using the motive fluid 12a into the recycle flash drum 25. The semi-lean solvent then continues through line 36 to semi-lean solvent chiller 38 and then through line 40 to carbon dioxide absorber unit 8. Also shown in the drawing is the treated gas leaving the top of carbon dioxide absorber unit 8 through line 60.

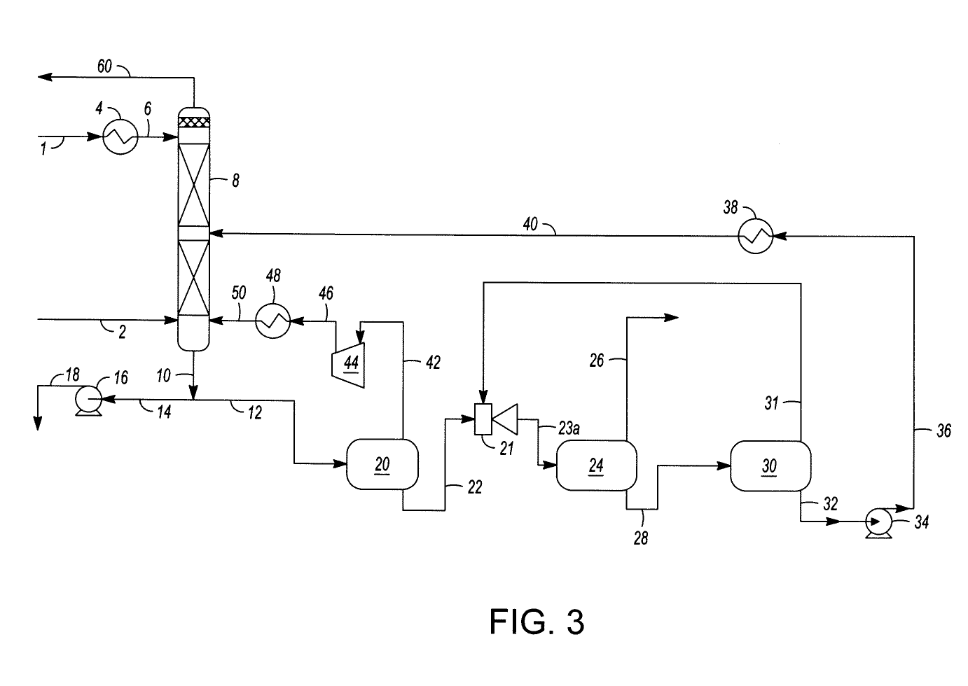

FIG. 3 shows an alternate embodiment of the invention in which an eductor is used in the regeneration of the solvent in the carbon dioxide capture section of a gas treatment plant. In this embodiment the eductor is placed after the recycle flash drum. In FIG. 3, a lean solvent 1 that has a low level of acid gases is chilled by lean solvent chiller 4. The chilled lean solvent passes through line 6 and enters carbon dioxide absorber unit 8 to contact a feed gas shown as entering the carbon dioxide absorber unit through line 2. The contact of the chilled lean solvent with the feed gas results in a loaded solvent exiting the bottom of the carbon dioxide absorber unit 8 through line 10. A portion of the loaded solvent passes through line 14 to loaded solvent pump 16 and then exits this portion of the process through line 18 where the loaded solvent is sent either to another absorber unit to remove other impurities such as hydrogen sulfide or the loaded solvent is sent to be regenerated as known to one skilled in the art. The remaining portion of the loaded solvent is sent through line 12 to recycle flash drum 20. A portion of the carbon dioxide gas exits recycle flash drum 20 though line 42 to be compressed in recycle compressor 44, go through line 46, cooled in carbon dioxide recycle cooler 48 and then reenter carbon dioxide absorber unit 8 through line 50. Liquid from recycle flash drum 20 is used as the motive fluid in line 22 passing through eductor 21 and into flash drum 24 as line 23a. The liquid contents of the vent drum passes though line 28 to vacuum drum 30 from which a vapor component passes though line 31 back to eductor 21 and a semi-lean solvent component passes through line 32 to semi-lean solvent pump 34 and then continues through line 36 to semi-lean solvent chiller 38 and then through line 40 to carbon dioxide absorber unit 8. Also shown in the drawing is the treated gas leaving the top of carbon dioxide absorber unit 8 through line 60.

Other embodiments may be employed that employ the basic principles of the present invention.

1. A process for treating a carbon dioxide containing gas comprising:
a) sending a feed gas containing carbon dioxide through an absorber unit containing a lean solvent to produce a loaded solvent containing a majority of said carbon dioxide from said feed gas and a treated gas;
b) sending at least a portion of said loaded solvent through an eductor together with a carbon dioxide containing gas to produce a gas-liquid mixture under increased pressure wherein said gas-liquid mixture comprises a solvent and said carbon dioxide;
c) sending said gas-liquid mixture to a carbon dioxide vent drum to vent a majority of said carbon dioxide from said gas-liquid mixture and producing a semi-lean solvent stream;
d) sending the liquid from said carbon dioxide vent drum to a vacuum flash drum to produce a carbon dioxide containing vapor stream and a semi-lean solvent liquid stream; and
e) recirculating said semi-lean solvent stream to said absorber unit.

2. The process of claim 1 wherein the loaded solvent first passes through a carbon dioxide recycle flash drum and then passes through said eductor.

3. The process of claim 1 wherein the loaded solvent passes through a carbon dioxide recycle flash drum after passing through said eductor.

4. The process of claim 1 wherein said solvent is selected from the group consisting of dimethylether of polyethylene glycol, methanol, a mixture of N-formyl and N-acetyl morpholine, N-methyl-2-pyrrolidone and sulfolane.

5. A process for regenerating a solvent comprising sending a motive fluid and a carbon dioxide containing gas though an eductor to create a gas-liquid mixture followed by removal of carbon dioxide from said gas-liquid mixture.

6. The process of claim 5 wherein solvent passes through a carbon dioxide absorber unit before passing through said eductor and then after being formed in said eductor said gas-liquid mixture passes through a carbon dioxide recycle flash drum to remove carbon dioxide from said gas-liquid mixture.

7. The process of claim 6 wherein after passing through said carbon dioxide recycle flash drum, said gas liquid mixture passes to a carbon dioxide vent drum to vent carbon dioxide.

8. A system for removal of carbon dioxide from a carbon dioxide containing solvent comprising a carbon dioxide absorber, a carbon dioxide recycle flash drum, an eductor and a carbon dioxide venting apparatus.

9. The system of claim 8 wherein said carbon dioxide recycle flash drum is located after said eductor.

10. The system of claim 9 wherein carbon dioxide recycle flash drum is located before said eductor.

11. The system of claim 8 wherein said carbon dioxide venting apparatus comprises a carbon dioxide vent drum.

12. The system of claim 8 wherein said solvent is selected from the group consisting of dimethylether of polyethylene glycol, methanol, a mixture of N-formyl and N-acetyl morpholine, N-methyl-2-pyrrolidone and sulfolane.
